(19) United States
(12) Patent Application Publication
(10) Pub. No.: US 2008/0204757 A1
(43) Pub. Date: Aug. 28, 2008

(54) Handheld FT-IR spectrometer

(76) Inventor: Christopher Manning, Troy, ID (US)

Correspondence Address: CHRISTOPHER MANNING, PO BOX 265, TROY, ID, 83871, US

(21) Appl. No.: 11/893,750

(22) Filed: Aug. 16, 2007

Related U.S. Application Data
(60) Provisional application No. 60/838,593, filed on Aug. 17, 2006.

(51) Int. Cl. G01B 9/02

(52) U.S. Cl. 356/451

(57) ABSTRACT

Novel spectrometer arrangements are described. They may employ a resin-based preconcentration system to sample chemical vapors. A field-widened interferometer modulates radiant energy. The signal generated by the interaction of the radiant energy with the sample is detected and processed by a computer. A variety of enhancements to the basic design are described, providing a family of related spectrometer designs. These spectrometers have applications in spectrometry, spectral imaging and metrology.

### RELATED APPLICATIONS

This application claims the benefit of Provisional Application Ser. No. 60/838,593.

Previous filings by the author are included by reference for the entirety of their disclosures. The first is Ser. No. 09/922,363, filed Aug. 2, 2001. Another is “Tilt-Compensated Interferometers,” filed Oct. 21, 2002, Ser. No. 10/277,439 which issued as U.S. Pat. No. 6,967,722 on Nov. 22, 2005. More are provisional applications Ser. No. 60/107,060, filed Nov. 4, 1998, titled “FT-IR Signal Processing: Part I,” Ser. No. 60/119,429, filed Feb. 9, 1999, titled “FT-IR Signal Processing: Part II,” a formal application entitled “Signal Processing for Interferometric Spectrometry” Ser. No. 09/433,964 filed Nov. 4, 1999. Further provisional applications which are included for the entirety of their disclosures are titled “Interferometers and Interferometry,” Ser. No. 60/228,800, filed Aug. 2, 2000, titled “Interferometers and Interferometry: Part 2,” Ser. No. 60/242,232, filed Oct. 17, 2000, and titled “Interferometers and Interferometry: Part 3,” Ser. No. 60/288,273 filed May 2, 2001. The book by Griffiths and deHaseth, “Fourier transform spectrometry,” ISBN 0-471-09902-3, also is included for the entirety of its content.

Portions of the inventions disclosed here have been made under contracts with the United States Federal Government through the Department of Defense under one or more of the following contracts DAAD-13-P-0012, DAAD13-02-C-0003, DAAD13-03-P-0076, W911-SR-04-C-0067, W911SR-05-C-0046, W911SR-05-P-0043, W911SR-06-C-0030. The Government has certain rights in these inventions.

### BACKGROUND AND SUMMARY OF THE INVENTION

It is an object of the present inventions to provide new interferometers, which are better than prior art in respect to size, sensitivity, scan speed, stability, throughput, data processing and/or cost of manufacture. It is an object of the present inventions to improve the state-of-the-art of interferometric measurements.

1. Prior Art

Much of the state of the art is described by various publications, including several detailed here. It is understood in the following discussion, for example, that reference lasers are used in interferometers for the purpose of measuring optical path difference. It is further understood that computers of various types ranging from mainframe to desktop workstations to embedded microcontrollers are used to control such instruments, acquire and process data. These details are well known to practitioners of the art and will not be discussed, except as they pertain to particular features of the new inventions.

The literature has been summarized in good detail by Griffiths and deHaseth in “Fourier Transform Infared Spectrometry,” ISBN 0-471-09902-3 published by Wiley-Interscience, which is included by reference for the entirety of its content. Other texts that describe points of theory relevant here include “Interferometry” by Steel, Library of Congress Catalogue Card Number 17-12140, published by Cambridge University Press, “Principles of Optics” by Born and Wolf, ISBN 0-08-026482-4, published by Pergamon Press. Numerous other books and articles are known to practioners in this field of endeavor. Numerous other relevant points of the prior art are specifically referenced below, but it is understood that there is a range of art that is well known but not described in great detail here.

2. Background

There is a pressing need for cost-effective, compact and portable instruments to detect airborne chemicals. The handheld infrared spectrometer described here provides highly sensitive, part per trillion to part per billion detection of a variety of toxic and dangerous substances. It is truly a revolutionary advance in the state of the art, including a substantial improvement in sensitivity of over current infrared photoacoustic spectrometers. Rapid detection and identification of unknown substances, particularly chemical warfare agents, explosives vapors from improvised devices, precursor materials for chemical and biological agent production and illicit drugs are important to personnel security worldwide. Other applications can include remote sensing from UAVs, monitoring the condition of lubricants in vehicles, detection of bioaerosols and personnel health monitoring. These instruments also can have widespread commercial applications to industrial, medical, agricultural, safety and environmental measurements, including quantitative and qualitative analysis of important commodities. For example, the device described here can quickly measure the octane, cetane and water content of fuels, the moisture content of grains and perform many other routine analytical tasks.

The usefulness of these devices hinges on unit cost and performance. The invention described here reduces the cost of portable infrared spectrometers by an order of magnitude. Equally important, it may advance the sensitivity by a factor of 1000. Some of the critical advancements in science and engineering that support this invention are a preconcentrator (providing 100× to 1000× increase in sensitivity), a high-index, field-widened interferometer (9× to 16× increase), high sensitivity microphone, and high efficiency infrared source. The combined effect of these advances can be a 1000-fold improvement in sensitivity.

The total instrument weight of the device can be less than 1 kilogram (˜2 pounds), with a cost of less than US$1000 per unit in large quantities. The instrument size can be compared to a scientific calculator from the early 1970's, being roughly 10 cm (4″) wide, 20 cm (8″) long and 5 cm (2″) thick. These dimensions allow adequate space for each component while maintaining a compact and portable configuration. Some configurations may be larger to incorporate other features.

A series of critical enabling technologies have made a miniature or handheld FT-IR spectrometer timely. Until recently, computing engines could not provide the necessary number of computational cycles using the limited power of batteries. Also, inexpensive commercial microphone technology generally has been of low sensitivity.

Photoacoustic detection is a highly sensitive technique that exploits the heat generated by infrared absorption, measuring the resulting acoustic pressure waves.[^{i,ii,iii}] The molecular bonds in essentially all airborne chemicals absorb characteristic infrared wavelengths and rapidly convert the absorbed radiation to heat. Unlike absorption measurements where a small change in a large signal must be detected to very high accuracy, photoacoustic output is quite small in the absence of airborne chemicals. Hence, the background for the measurement is the thermal noise of air molecules impacting the microphone diaphragm.

### BACKGROUND

Fourier transform-infrared (FT-IR) instruments are highly effective tools for molecular analysis. All airborne chemicals including chemical warfare agents, explosive vapors and drug lab emissions have characteristic molecular signatures that can be detected by infrared radiation. The novel miniature or handheld instrument proposed here is a modular Fourier-transform infrared spectrometer, which can be configured for photoacoustic detection of gas phase species. Photoacoustic detection is a highly sensitive technique that exploits the heat generated by infrared absorption, and the resulting acoustic pressure waves.

In general, Fourier transform-infrared (FT-IR) instruments are highly effective tools for molecular analysis. A number of portable FT-IR instruments have been fielded, but the smallest of these is somewhat larger than a briefcase, while most are larger. These instruments combine relatively high throughput with the multiplex advantage, resulting in very high sensitivity. Field widening can dramatically increase throughput and, consequently, sensitivity. The increased throughput also can allow a reduction in overall instrument size. The Joint Services-Lightweight Standoff Chemical Agent Detector (JS-LSCAD) has very good instrinsic selectivity, but only moderate sensitivity because of the limited throughput. The use of field widened interferometer could increase its throughput and sensitivity by up to 16× in the same footprint. In the devices described here, field widening can be used to reduce interferometer size to a handheld footprint, while preserving sensitivity.

An appropriate spectral resolution for many measurements, including solids, liquids and most gases, is 4 cm⁻¹, which provides 900 spectral elements over the mid-infrared spectral range (2.5 to 25 microns, or 4000 to 400 cm⁻¹). A large number of orthogonal spectral components allows very high selectivity; even highly overlapped spectral signatures can be resolved with high quantitative accuracy.[^{iv,v,vi}] A key enhancement to the selectivity comes from another advantage of Fourier transform instruments. Sometimes called the Connes advantage, [see, for example, Griffiths] or the registration advantage, it is the highly accurate frequency calibration that results from the use of an internal reference laser. The part-per-million x-axis accuracy substantially improves the discriminating power relative to a dispersive instrument of the same throughput and resolution. Conventional instruments employ helium-neon (HeNe) lasers,[^{vii}] which are highly stable and repeatable from unit to unit. However, they are quite large (15 to 25 cm lengths) relative to handheld footprints, have very low power efficiency (0.01%), excessive power consumption and waste heat (˜15 watts), shock sensitivity and limited operating lifespan (2,000 to 10,000 hours). Where size, power and ruggedness are at a high premium, semiconductor diode lasers are an excellent choice. They have essentially infinite life, especially the vertical cavity surface emitting (VCSEL) type. Unfortunately, their frequency stability generally is inadequate for FT-IR measurements, being about 3 orders of magnitude worse than the HeNe type. However, with the combination of a quartz Fabry-Perot waveplate and feedback control by a digital signal processor, diode lasers have recently been demonstrated[^{vii}] to provide part-per-million frequency stability. A more compact self-contained laser module with very low power logic is proposed to make the diode lasers more useful for handheld instruments, as well as providing a drop-in replacement (retrofit) for HeNe lasers in existing instruments. Good HeNe lasers cost about US$330 each, so the use of a $50 diode laser, even with the cost of a small etalon ($10) and suitable electronics ($20) represents a significant cost savings. It should be noted that the author has been issued U.S. Pat. No. 7,224,464 which a method for employing diode lasers in FT-IR spectrometers.

### Preconcentrator

To provide extra sensitivity for determination of airborne chemical agents at and below the threshold of human symptoms, a preconcentration stage is very helpful. Preconcentrators are well known in the field of gas chromatography,[^{ix}] but are thought not to have been used in FT-IR systems. The principle of operation is two-fold. First, the higher differential solubility of organic vapors in some materials, relative to air, concentrates or captures vapors from a large volume of air passed over a material, typically a polymer. In the practice of gas chromatography, this phenomenon frequently is called solid phase extraction (SPE). After a sampling interval, heating (or, in some cases, pressure shift) causes the captured vapors to be released from the polymer and pass into a small volume of air or gas, providing much higher concentrations to the detection unit. A field-widened interferometer can provide dramatically higher energy throughput to maximize the acoustic power generated and transferred to the detector. The use of a field-widened interferometer can provide 10 to 25 times the energy throughput of a conventional interferometer of the same aperture dimensions. Of course, the aperture size can be limited by a handheld or miniature instrument footprint, but field-widening can allow the throughput to exceed that of much larger benchtop instruments. Typical benchtop instruments have aperture diameters of 2.5 to 5 cm, which provides throughput comparable to field-widened instruments with apertures of 0.5 to 1 cm. The largest practical aperture diameter for handheld instruments probably is between 1 and 2 centimeters.

### Infrared Source

A high-efficiency infrared source can further improve sensitivity and reduce power consumption. Some novel sources are based on structured metal radiator surfaces.[^{x,xi}] Structured metal surfaces have been used for some time in frequency-selective[^{xii}] and switchable radar reflecting surfaces[^{xiii}], and more recently for infrared applications.[^{xiv}] Photonic crystals and structured surfaces have been demonstrated to have tailored emissivity profiles.[^{x,xi}] Conventional infrared sources also can be used. The concept is quite straightforward—structured metal surfaces can have an emissivity spectrum that is not a simple blackbody radiator. The advantage is that the emissivity can be high in spectral regions of interest, such as the mid-infrared range where almost all airborne chemical species have strong absorptions, and low in other regions—particularly the near-infrared and visible spectral ranges where the bulk of the blackbody energy is emitted for source temperatures in the range of 1500K. For a blackbody radiator at practical temperatures (˜1500K), the output power emission peaks in the visible wavelength range where it is not useful. Lowering the emissivity of the source as close to zero as possible in the near-infrared and visible ranges can increase the power efficiency by roughly a factor of 10. Other contributions to source inefficiency are conductive heat leakage and convective heat leakage. These losses also can be minimized by judicious engineering.

Another useful approach to a highly efficient source is to use a conventional blackbody in a vacuum insulating chamber with highly reflective walls. The output spectrum can be controlled by an infrared filter element on a gallium arsenide source window. It is estimated that the source power consumption can be reduced to less than 5 watts. Effort applied to the problem of source efficiency is highly relevant, because source power consumption is a major component of FT-IR system power budgets. This is especially true if the other major power budget problems, the reference laser and computer, have been resolved as described herein. The only other significant power budget items are the preconcentrator and the signal processing electronics. The power consumption of electronics is being reduced dramatically by ongoing commercial efforts in the semiconductor industry. The preconcentrator power consumption can be the largest remaining item in the power budget, but is mitigated as described below.

### Detection Method

Photoacoustic detection provides the potential for very low cost instrumentation and very sensitive measurements. The mercury-cadmium-telluride (MCT) detectors employed in conventional infrared measurements cost roughly US$1000 to $2000 each and require the use of a relatively expensive long-path gas cell, as well as the aforementioned problem of detecting a small signal in the presence of a large background. High-sensitivity nickel-membrane microphones (e.g., Model 4176, Bruel & Kjaer Products, Nærum, Denmark) are themselves quite expensive, being about the same US$1000 cost as MCT detectors. However, mass production via silicon micromachining of microelectromechanical systems (MEMS) offers the potential of even greater sensitivity at dramatically lower costs. The micromachined accelerometers from Analog Devices (ADXL213, Norwood, Mass.), which are of similar complexity to MEMS microphones, are manufactured in large quantities. These devices cost only US$5.50 each, in quantities of 10,000 units. High sensitivity microphones also can be manufactured in very large quantities and could be expected to have similarly low cost. For example, Knowles Electronics (Itasca, Ill.) manufactures the model SPM0102ND3 silicon MEMS microphone for about $2 each, in vast quantities. While the volume production of PAS microphones probably can not achieve the full economy of scale of consumer devices, the technology is still very cost-effective compared to conventional high-sensitivity microphones.

It should be noted that several portable FT-IR systems have been fielded by manufacturers in the US, Denmark, Japan and Finland. The Temet Instruments line, (Temet Instruments Oy, Helsinki, Finland) is aimed at detection of gases, generally using long-path gas cells and thermoelectrically (TE)-cooled MCT detectors. One of these devices occupied a large luggage cart and weighed over 50 pounds. The lightest of Temet FT-IR instruments weighs 16 kilograms, consumes 300 watts of power and is mounted on a small handcart. SensIR (now part of Smith's Detection) of Danbury, Conn. has produced a series of portable FT-IR instruments that are between shoebox and suitcase size, being somewhat lighter than the Temet instruments. Innova AirTech Instruments A/S (Ballerup, Denmark) manufactures a photoacoustic instrument for field use. It is based on spectral filters and can only detect a limited number of species. Further, it is too costly for widespread deployment. To date, no FT-IR instruments have yet been manufactured in a handheld footprint. The instrument described here is revolutionary in several respects.

### Infrared Source

Typical Fourier transform-infrared (FT-IR) spectrometers employ silicon carbide elements as the IR source. These devices are manufactured in very large quantities for use as gas igniters. The general construction is a cylindrical mullite ceramic base about 1 cm in diameter and 3 cm long. Embedded in the ceramic base are two high temperature wires and the silicon carbide element in the shape of a hairpin. The silicon carbide (SiC) is a semiconductor that can be heated readily by passing electricity through it via the leadwires. At high temperatures, such as 1500 Kelvin, the SiC can have a very high emissivity.

Common gas igniters are relatively inexpensive (˜US$20 each) and consume between 10 and 30 watts, generating an infrared beam with a power in the range of tens to hundreds of milliwatts. The SiC has a high thermal conductivity that sinks a portion of the element heat into the ceramic base and to the wires that supply the current. Given that only several tens of milliwatts to two watts of optical power are relevant to spectrometer operation, there is considerable room for efficiency improvement. An infrared source can have almost 100% efficiency, if conduction, convection and radiation losses from the source are minimized. Radiation losses include infrared radiation that propagates away from the source in undesirable directions, and radiation of unusable wavelengths that propagates in the desired directions. These losses can be minimized by the use of insulation to block the flow of heat and radiation in undesirable directions. Many ceramic insulation materials are transparent to infrared radiation over wide spectral ranges. Insulation materials with high emissivity that can block radiation have a relatively high radiative coupling that partially negates their advantage. Alternatively, or in combination with insulation, an infrared reflector can return much of the otherwise wasted radiation to the source element, thereby increasing the efficiency. The silicon carbide source material has a high and relatively uniform emissivity over the spectral range of interest. At ambient temperature, the emissivity of pure silicon carbide is quite low and it can be used as an infrared window. It does have strong absorption (and hence, high emissivity) at 840 cm-1 with a shoulder at 950 cm-1.

### Source

One preferred type of high-efficiency infrared source is based on structured emitting materials having tailored emissivities. The preferred source has an emissivity spectrum or profile tailored[^{xii,xiii,x,xi}] to maximize the source intensity in the useful spectral range, while minimizing the source intensity in unused spectral ranges. This allows the source to be operated at higher temperatures for a given input power, increasing the useful radiation output and increasing the signal-to-noise ratio of the measurements. It should be noted that the support for the source and the method of heating are critical to the successful use of tailored emissivity materials. The material cannot be supported on a metal substrate because the high emissivity [of heated metal] can dominate the spectral properties in the regions where low emissivity is desired. Another problem with metal substrates is their high thermal conductivity, which tend to waste power.

The advantages of the Ion Optics devices include low cost; the devices can be fabricated by techniques similar to those used for semiconductor manufacturing. Absent further improvements such as the vacuum chamber and reflectors, their efficiency cannot be as high as the preferred approach described below. The efficiency of sources made by the preferred approach is close to 90%, in comparison to the ˜0.01 to 5% efficiency of conventional FT-IR sources. Thus, they offer very high energy efficiency and tailored spectral output.

The lead wires used for the electrical connection to the source provide a heat conduction path, reducing the overall efficiency. Alternative methods of heating the source with reduced heat conduction paths are described below and substantially increase source efficiency. Reducing the heat conduction path through air also is highly beneficial to efficiency. The only other requirements for high efficiency are to tailor the spectral output to contain only useful wavelengths and to eliminate radiation propagating in unusable directions. The useful wavelengths are selected by a infrared passband filter. The radiation propagating in unwanted directions can be returned with a spherical reflector mounted around the source. The preferred approach is to heating electron impact.

The main difference between the structured sources and the preferred approach is that the tailored spectral profile can be obtained by the use of a filter element, sometimes called a cold filter or dichroic mirror. Infrared filters are well-established commercial technology, although they have not appeared in the practice or literature of infrared spectrometer sources. The concept is quite similar to the cold filters that are used in slide projectors to remove near- and mid-infrared radiation from the visible beam used to illuminate the slide. If a slide projector is used without such a filter, it can quickly melt (or combust) slides. General Electric, Westinghouse, Philips and others have used similar approaches for many years to increase the efficiency of incandescent and tungsten halide lamps.[^{xv}]

An aluminum block was machined with a hollow spherical vacuum cavity. The inside of the cavity was polished and the reflector surface gold-coated to enhance IR reflectivity. The exploded diagram shows that the hollow block is comprised of two hemispherical reflectors. Two well-suited candidates for the target (emitting) element are silicon carbide and graphite. Silicon carbide performs well in this application, but requires diamond grinding to shape, unless it is shaped while green. Further, drilling holes in it for the support rods is quite difficult. Graphite (PN 9121K72, McMaster Carr) was used for prototyping due to its ease of machining, low cost and strong emissivity/absorption. The graphite target element is shown in supported at the center of a 1.25-inch diameter spherical cavity by highly insulating (thermal conductivity=2.2 W/mK) zirconia ceramic rods of 1/16-inch diameter (PN 8750K31, McMaster-Carr Supply Company).

An insulated feedthrough was provided to allow electron impact heating. A vacuum fitting KF-16 (PN KF16-¼, Duniway Stockroom Corporation, Mountain View, Calif.) is attached to the chamber to allow evacuation. An IR-transparent window is shown at the lower right. As described below, it preferably is gallium arsenide. Several vendors can provide coatings for gallium arsenide. At present, this is the preferred material for the window/filter because of its better tolerance for high temperatures (lower absorption), its higher thermal conductivity and its wider spectral window relative to germanium.

### Electron Impact Heating

Electron impact is an attractive option for contactless heating of the source element. The kinetic energy of the electrons are transferred to the source as heat. A convenient source of electrons is a themmionic emitter as discovered by Edison.[^{xvi}]

The target element absorbs radiation from a 4 watt diode laser, described above, through a quartz window (PN 1357T21, McMaster-Carr Supply Company) on one end. A mechanical vacuum pump (Alcatel Pascal 2010 SD, Duniway Stockroom Corporation, Mountain View, Calif.) was used to evacuate the cavity. Chamber pressure was measured to be in the range of 4 milliTorr with a thermocouple gauge (Model 1515, Welch Vacuum Technology, Skokie, Ill.).

Critical considerations for the source are high efficiency, adequate lifespan, and compact size. The waste heat from the source must be rejected without excessively raising the instrument temperature. The preferred source element has high emissivity, as well as a tolerance for operating temperatures in the range of 1200 C and higher. Suitable materials include graphite and silicon carbide. The source can be thermally isolated from the environment by a vacuum chamber and zirconium oxide insulating supports of 0.75 mm (0.031″) diameter, as demonstrated above. The spherical chamber around the element can be coated with a suitable highly reflective coating, with the preferred materials being aluminum, silver and gold. Selective emission of mid-infrared wavelengths can be achieved by using a gallium arsenide window with a wavelength-selective filter/anti-reflection coating. The window can be as small as possible while achieving the required source aperture. Radiation at wavelengths shorter than the mid-infrared can be reflected back from the window to the source, effectively recycling the energy. Essentially all of the energy reaching the spherical reflector can be returned to the source.

The preferred approach is to heat the source by electron impact. The source element preferably is charted to +350 volts, allowing electron transfer from a grounded thermionic emitter. The source element itself can require an electrical connection to a power supply like the one described herein for a piezo element. A voltage of 300 to 350 volts at a current of 10 milliamps is required, corresponding to a power dissipation of 3 watts. A very thin (12.7 microns) tungsten wire can be an excellent choice for the electrical connection (PN W89, Scientific Instrument Services, Ringoes, N.J.). The parasitic heat loss for the wire is only about 1 milliwatt. Because the current is so small, a resistance of several tens or even hundreds of ohms would not be a problem, but the electrical resistance is of the preferred wire is only 10 ohms for a 2.5 cm length. The relatively high resistance is needed to minimize the parasitic heat flow path through the wire. The tungsten wire can approach the source element from an angle that can preclude electron impact heating of the wire itself, which would waste energy.

Thermionic emission from filaments is preferred. The thoriated tungsten filaments in vacuum tube devices are ideal for thermionic emission and can manufactured for pennies each, including all of the glass, Kovar, and metallic components. The estimated life of a thermionic emitter is 10,000 to 50,000 hours, depending on the operating temperature. Because of the low current requirement for electron impact heating, a lower filament temperature is preferred for a longer operating lifetime. A small high voltage power supply is preferred to drive the electron impact heating. At higher voltages, less current can be required to achieve the same heat delivery. However, if the voltage is too high, emission of soft x-rays can result. For low energy x-rays, the gallium arsenide window and the aluminum source chamber can provide sufficient shielding. At 300 volts acceleration potential, a heating current of about 10 milliamps can be required.

The source power consumption can be estimated from a geometric series. If 90% of the energy emitted by the blackbody element is returned by reflection, then the required source power input is reduced by a factor of 10 over what it would be for the same source operating in the open. The expression for reduction of power is 1/(1-a) where a is the reflection coefficient. The series arises from the interplay between the blackbody emission from the source and the power returned to the source by the spherical reflector cavity around it. The total blackbody emission power for a source of 6 mm diameter and 1 mm thickness operating at 1500K is estimated to be 29 watts. With 90% reflection from the cavity walls, the input power requirement drops to 2.9 watts, well within the power budget of a handheld or miniature instrument as described herein.

A turbopump can be required both for bringing the vacuum evaporation chamber to the correct operating pressure for reflector deposition and for bringing the source chamber to the correct operating pressure. To maintain a suitable high vacuum, appropriate for operation of a source at high temperature, it can be necessary to have good (“hard”) vacuum seals and a getter. A getter is a reactive metal that can sequester oxygen, nitrogen and other gases. The most commonly used one in radio tubes was a barium wire, called a flash getter. The barium wire was heated electrically to evaporate it, producing the silver spots commonly seen on radio tubes. While a variety of getter materials can be used, barium is particularly effective for removing oxygen, nitrogen and hydrogen. Some of the gases can be released by other materials in the tube, such as heating of iron, rather than being from leaks.

The source can require feedthroughs for filament heating and for electrical connection to the element. The feedthroughs must be hard sealed. For many years, the hard glass-to-metal seals on radio tubes were made by melting glass around Kovar® alloy, which has an expansion coefficient matched to borosilicate glass. The preferred source body is aluminum, which is highly conductive and a poor coefficent match to glass. Thus, sealing must be accomplished at two levels. First, electrically insulating hard-sealed glass rods can carry Kovar® conductors to the internal elements. The conductors can carry only a minute current, so can be fabricated from very thin wire. The conductor can transition to Kovar® where it is sealed to glass. However, glass provides a poor coefficient match to aluminum. Indium metal seals are quite compliant, so even with the poor coefficient match of indium (33 ppm/C) to aluminum (˜24 ppm/C) and glass (5 to 10 ppm/C depending on type), a good seal can be maintained. Crushing indium against a glass feedthrough can allow the indium expansion mismatch to exactly offset the mismatch between glass and aluminum.

A gallium arsenide window material is not an ideal coefficient match either to the aluminum source chamber or indium seals. Gallium arsenide has an expansion coefficient of only about 5 ppm/C. For a window diameter of 1 cm, the coefficient mismatch over a −50 to +50 service temperature range would imply an uncompensated expansion of 17 microns relative to the aluminum source reflector/housing. This can be accommodated by making the indium gasket thicker, or by using two indium seals and an intermediate ring of stainless steel (˜15 ppm/C) as a transition. Alternatively, a flexible metal ring can be used, manufactured from a thin foil.

To provide for rapid warmup of the source element and high instrument stability, it is preferred to provide closed-loop temperature control of the active element. The preferred method is to use a silicon photodiode to monitor the near-infrared output of the source. A small aperture in the source cavity is sealed to a glass rod to provide a line of sight to a silicon photodiode. The signal from the silicon photodiode can be used to modify the power supplied to the element to maintain very constant infrared output.

### Interferometer

Numerous interferometer configurations can be considered for a handheld instrument. In general, high throughput designs, such as the Michelson geometry, are preferred to maximize the power transferred to the photoacoustic cell. One preferred geometry is manufactured from a set of prisms. The photoacoustic signal is proportional to the optical power transmitted to the sample. Microphone saturation is very unlikely to occur with gas phase samples, because the absorbed power is limited. It should be noted that even a photoacoustic sensor (PAS) signal that is saturated as a function of absorption still scales linearly with incident beam power. Thus, the signal can not saturate due to the microphone, nor the PAS signal itself. The critical tradeoff between interferometer size and signal-to-noise performance is that the throughput is proportional to the aperture area. In general, the interferometer volume scales as the third power of the aperture dimension. Because volume can be quite limited in a handheld instrument, throughput is a critical issue. The maximum practical aperture diameter for a handheld instrument probably is in the range of 2.5 cm (1″) to 1.25 cm (½″).

### Field-Widening

To maximize the effectiveness of the aperture area, a field-widened interferometer is preferred. Field widening refers to a modification of the wavefront curvature in the interferometer; alternatively, field widening can be conceptualized as matching, at the detector, the size of the source images coming from the two arms of the interferometer. At zero path difference (ZPD), the source images are identical in size and divergence, leading to an infinitely wide field of view. However, as one mirror moves away from ZPD, its corresponding source image can grow because of the divergent rays. The divergence of the rays is governed by the input optics and source size. The interference fringes of interest can blur, and eventually disappear, if the input optics and source size are not matched to the field of view of the interferometer. A complementary view is that the throughput limitation of interferometers arises from a mismatch of curvature between the wavefronts coming from the two arms. The mismatch leads to a variation of optical path difference across the field of view, which causes blurring and loss of contrast in the interference fringes. At ZPD, wavefront curvatures generally match exactly, giving an infinite field of view. As the path difference is displaced from zero, the different propagation distances in the two arms leads to a mismatch of the wavefront curvatures, again for the divergent rays.

Very few field-widened interferometers have been reported in the literature,[^{xvii,xviii,xix}] although the concepts have been known for many years. One example of such a device is Doyle's design,[^{xx}] which has been sold for many years under the Analect and Laser Precision Analytical names. At present, it is sold by Hamilton-Sundstrand (Pomona, Calif.), a division of United Technologies, Inc. (Hartford, Conn.). The field widening of Doyle's design usually is modest, because most versions, if not all, employ potassium bromide (KBr) scanning wedges and scan only the wedge. The refractive index of KBr is only about 1.5, providing a relatively small degree (2×) of field widening KBr is an inexpensive and highly transparent infrared material, compared to germanium, zinc selenide and other higher index materials. A higher refractive index increases the energy throughput, allowing for a smaller device footprint in return for a more expensive component.

The preferred method for operating a field-widened interferometer is to couple the motion of one of the moving mirrors to the motion of the KBr prism/wedge. Thw faces of each prism must be polished to interferometric tolerances.

### Reference Laser

Preferably a diode reference laser will be used in the spectrometer system, with the diode laser wavelength locked to a physical standard, preferably a temperature-stable etalon. This approach has been presented in the literature[^{vii}] and is the subject of a US patent.[^{xxi}] The reference laser can be divided into multiple beams to probe the tilt of the moving assembly, as well as the motion along the optical retardation axis.[see Raul Curbelo's patent]

The limits of stabilization performance have not been measured fully, in part because this step can require a stabilized Helium-Neon laser (e.g., 05 STP 901, Melles Griot, Carlsbad, Calif.) which is fairly expensive. However, preliminary testing indicates that the approach is highly useful and suitable for part per million stabilization.

### Interferometer Scanning

The most common drive mechanisms for scanning interferometers are voice coil linear motors, such as those sold be BEI Kimco (San Marcos, Calif.). One disadvantage relative to solenoids is that any heat generated by the coil must be carried by the air in the magnet gap, unless other cooling provisions are made. Ferrofluids have been used for the purpose of improved cooling,[^{xxii}] but they are a potential source of system and optical contamination. Voice coil motors employ a moving coil in a magnetic field to produce a force that is proportional to the field strength, the length of wire in the field and the current in the wire. The performance can be improved considerably by the use of rare earth magnets. The use of voice coil drive is reasonable for miniature, battery-powered or handheld instruments

### Preconcentrator

Preconcentrator operation has been demonstrated conclusively by reports in the literature,[^{ix,xxii}] by modeling with information published on the web by Scientific Instrument Services, Inc., (Ringoes, N.J.), and through testing with a prototype preconcentrator described herein. Much effort has been expended by scientists in the identification of resins for preconcentrating various chemical vapors. The literature indicates that concentration ratios of 20 to 1000 can be expected.[^{ix}] Tenax™ TA resin (PN SKC-226-357, SKC-West, Inc., Fullerton, Pa.) is preferred at present. Other options include carbon-based resins (e.g., Carbosieve S-III, Supelco, Inc., Bellefonte, Pa.) and fluoroepoxy compounds.[^{xxiv}]

The concept of preconcentrator function is straightforward; samples of air are drawn through the resin material at a temperature conducive to absorption based on analyte volitility. The preconcentrator is intended to concentrate by a factor of 1000:1, drawing in 1 liter of ambient air per minute and reducing it to a 1 mL sample in the PA cell, with a new sample each minute. For typical chemical agent simulants, the appropriate collection temperatures are between 10 and 40 degrees Celsius. The resin is then heated, generally beyond the boiling point of the analytes of interest, which are driven out of the resin, then out of the resin air space as vapors by a pump. Three resin tubes can be employed to allow efficient cycling through three sampling phases: I) analyte collection, 2) analyte desorption, and 3) cartridge cooling. Heating can proceed rapidly; for example, with 6 watts of energy input, the tube can reach temperature in less than 30 seconds, but cooling can require about one minute.

Critical design considerations pertaining to the preconcentrator module are physical layout, power budget and temperature control. Absorption and desorption of analytes in the resin are controlled by thermal cycling. At present, the preferred method for heating the resin is the use of battery power The preconcentrator is likely to have the largest power budget in the system, possibly consuming as much as 5 watts or more of average power. Two significant power consumption issues are driving air through the preconcentration resin and heating the resin to desorb compounds. The preconcentrator can function by passing ambient air over an absorbing material, which can be Tenax™ TA resin, to absorb compounds from the air. Tenax™ TA resin is a porous 2,6-diphenylene-oxide resin, a type of epoxide. After the air is driven over the material for a period of time (1 minute is a suitable period for many applications), the resin can be heated to release trapped organic vapors. Many polymer materials preferentially concentrate airborne chemical vapors because of differential solubility.[^{ix,xxiv}] The absorption process can be reversed by heating of the polymer (temperature shift) or by changing the air pressure on the loaded material (pressure shift). The pressure shift absorption technique is fairly well known for drying air.[^{xxv}]

For Tenax™ TA resin, the maximum temperature of operation is 350 C in an inert atmosphere. For portable instruments, it can be inconvenient to provide a supply of inert gas, so air can be used. The upper temperature limit for Tenax™ TA resin operating in air is 200 C. Operation at higher temperatures can result in decreasing effectivness because of permanent resin degradation. It may be found that the resin degrades slightly even within these temperature limits. If that is the case, then periodic maintenence procedures can specify resin cartridge replacement at appropriate intervals, probably longer than 6 months of continuous operation. To promote rapid transfer of heat into the resin, it is advantageous for the resin to be packed into a porous metal foam. For example, nickel foam (Ampormat 200, Astro Met, Inc., Cincinatti, Ohio, or INCOFOAM, Mississauga, Ontario, CANADA) has a much higher thermal conductivity than the resin. This is critical to rapid heat transfer into the resin, without damaging the resin in close contact with the heat source by using too large a thermal gradient.

The resin can be encloseed in a thin-wall aluminum tube, in which a piece of the metal foam is inserted and packed with resin. An appropriate outside diameter for the tube is 0.5″, because a standard off-the-shelf anodized aluminum heatsink for TO-5 electronic packages (PN 326005B00000, Aavid Thermalloy, Laconia, N.H.). The heatsink is 0.375″ long, so 2 or 3 are appropriate for the length of the resin containing tube. In the center of the nickel foam, a standard ⅛″ diameter cartridge heater (e.g., PN C2A5-E12, Watlow, Saint Louis, Mo.) can provide 6 watts of heating. The standard cartridge heaters are intended for operation from a 120 volt AC supply, but operating from a 12 volt supply, their output is reduced by 100×. Thus, the 600 watt cartridge is appropriate for this application. A temperature sensor must be located with the cartridge heater in the middle of the nickel foam, so that the power input does not cause the temperature of the resin to exceed 200 C. Aluminum foam is more thermally conductive than nickel, as is copper. Both are available from Reade Advanced Materials (Providence, R.I.). A Sunon fan (PN KDE0517PDB2-8(2)V) is 17 mm×17 mm×8 mm thick, moves 0.8 cubic feet per minute, about 28 liters per minute. Given that the heat capacity of air is about 1 Joule/gram C, these blowers, which consume 0.6 watts, are more than adequate for cooling the resin tubes in the allotted 1 minute time period. The cooling effect can be boosted by the use of Peltier cooling devices, but they are rather inefficient and power consuming. For example, a typical part (Melcor, Trenton, N.J.) moves 28.7 watts between two fluids at the same temperature with an input power of 52 watts. The use of a Peltier cooler also can allow the resin tubes to operate below ambient for trapping more volatile agents and TICS in warm climates.

The dangerous level, frequently designated permissible exposure limits (PEL) for airborne chemical warfare agents, is roughly part per billion. Industrial practice also recognizes Occupational Safety and Health Organization (OSHA) designations of immediate danger to life and health (IDLH) and recommended exposure limits (REL). It is desirable to detect organic vapors, including chemical agents, well below this level. The sensitivity of PAS gas detection without preconcentration is in the range of parts per million to parts per billion, depending on the infrared absorption strength of the analyte, the source intensity, interferometer throughput and the microphone sensitivity. To achieve the desired level of sensitivity, that is, to be able to detect airborne chemical warfare agents well below the PEL, it is necessary to concentrate the agents by at least 1 order of magnitude, and preferably about 3 orders of magnitude. The resulting sensitivity of the instrument can then be in the range of parts per trillion to parts per billion.

### Resin Heating and Vapor Desorption

The power required to heat the resin has been carefully estimated and is well within the reach of rechargeable batteries. Heating of the polymer material needs to proceed very rapidly, which is difficult for a material that has a large surface area (and consequently high porosity). By inference, the space between the polymer elements, be they fibers, powder, or films, can be filled with air that has a low thermal conductivity.

The heat capacity of the Tenax™ TA resin is comparable to other organic materials, in the range of 0.4 calories/gram-degree C., or 1.6 Joules/gram-C. The numbers are much more favorable if only 0.1 grams of resin are used. The same input power of 5 watts raise the temperature in only 7.2 seconds, with an average power consumption of 2.4 watts. To heat 250 milligrams of resin over the range of 20 C to 200 C can require about 72 Joules. This neglects the mass of the container that must be heated, but it can be minimized by judicious choice of shape and materials. To achieve this heating in 30 seconds, corresponding to a 1-minute cycle time, can require about 2 watts. Thus, it may be possible to hold the preconcentrator power budget to as little as 5 watts.

Thus, the heating is best done via conduction, which requires a high thermal conductivity path extending into the polymer material. For example, Dr. Jay Grate of Pacific Northwest National Laboratories has described[^{ix}] the use of a tube filled with nickel foam as a heat spreader for Tenax™ TA resin. Using a similar approach, 20 watts of input power applied to the heaters can bring 1 gram of resin to 200 C in 12 seconds, after which they can be switched off until the next cycle. This would represent an average power consumption of 4 watts; combined with the blower that forces air through the resin, the power estimate of 5 watts would be very close. After the extraction step, airflow can resume. Air flowing through the resin material can quickly cool it down from 200 C to ambient. The heat capacity of air is about 1 Joule per gram degree C.[^{xxvi}] Thus, each liter of air passing through the system can reduce the temperature differential by about half. Dr. Grate had observed that some preconcentration tubes spontaneously fail[^{xxiii}] and it was thought that overtemperature might be responsible for damage to the resin. Using small quantities (250 milligrams) of Tenax™ TA, Dr. Grate was routinely observing a concentration multiplication of 20 to 25, but notes that the factor depends on several variables, particularly flow rate during desorption. He notes that breakthrough occurs only at very high concentrations of dimethyl methylphosphonate (DMMP). Dr. Grate observes that carbon is good for concentrating DMMP and similar materials, but that it must be heated to a much higher temperature for desorption. DMMP also has a high affinity for walls in transfer lines, so they preferably are heated. Good results were obtained with polytetrafluoroethylene and glass-lined nickel. The power for heated transfer lines must be included in the power budget, although it can be small.

An off-the-shelf preconcentrator module was obtained from SKC, Inc. (Eighty Four, Pa.) employing Tenax™ TA resin. SKC provides a wide range of sampling accessories, including a variety of bulk and packaged sorbent resins. The part number ordered was SKC-226-357, which contains 250 mg of Tenax™ TA resin. The SKC sorbent tube is ¼″ diameter×3½″ length of stainless steel tubing.

Micro valves are used to direct airflows through the resin, first from the ambient to the ambient for extraction of vapors. During thermal desorption, a small quantity of gas must be flushed through the resin and into the photoacoustic chamber. Valve function is described more fully below.

### Miniature Pump

A rotary vane pump was used draw vapors through the Tenax™ TA resin described above. Rotary vane pumps are very simple. A rotor is off-center in a cylindrical cavity. The rotor has slots in it containing vanes. When the rotor turns, the volumes trapped between the vanes change with angle, such that fluid is drawn in on one side and exits on the other. This is a positive displacement pump. The pump can contribute 0.09 pounds to the concentrator module (and overall instrument) weight. Power consumption is listed by the manufacturer at maximum of 1.8 watts with a continuous flow rating of 0.9 liters/min. The pump runs from a 6 volt DC supply, with a current draw between 18 and 30 millamps, depending on load. The maximum pressure that this pump can deliver is 0.3 psi, but the maximum continuous rating is 0.1 psi. Using this pump, a cycle time of 10 minutes can be required to move 1 liter of air through the resin.

The pump lifespan is not rated, but the motor has brushes and sleeve bearing. Motors of this type rarely exceed 10,000 hour lifespan[^{xxvii}]. For continuous operation, a brushless DC motor with ball bearings can provide lifespans in the range of 100,000 hours, over 10 years of continuous operation. The vane life can then be the life-limiting component. Scroll pumps offer virtually infinite life, so might be preferred for versions of the instrument that can see continuous duty.

### Breadboard Preconcentrator Prototype

A benchtop prototype was assembled for testing preconcentration efficiency. The 5 cm×10 cm×3.8 cm 2011 aluminum alloy (Alcobra, Spokane, Wash.) block was machined to house a resin preconcentrator tube, cartridge heater, and platinum resistance temperature detector (RTD). Swagelok ferrule fittings (PN A-400-2, Swagelok, Solon, Ohio) were used to connect 5/32″ ID high purity perfluoroalkoxy (PFA) 450 tubing (PN 52705K33, McMaster-Carr Supply Company) to each component in the assembly. PFA is a polymer similar to polytetrafluorethylene that also is sold under the Teflon® tradename, but has the advantage that it can be injection molded to close tolerances, as well as extruded. It also is without plasticizers that can contaminate fluids. PFA is inert to most chemicals and offers good resistance to extreme temperatures and UV exposure.

To reach a release temperature of 200 C, the aluminum block (and resin tube) are heated using a 100-watt cartridge heater. This cartridge consists of a wrapped nickel-chromium resistance wire insulated with magnesium oxide and sheathed in a stainless steel tube. The air gap between cartridge heater and the wall is critical to long life because added thermal resistance causes the cartridge operating temperature to rise. The hole diameter was held to less than one thousandth of an inch over the cartridge diameter as recommended by the manufacturer for the surface heat flux. The block temperature is controlled using a temperature controller, which is capable of maintaining temperature within about 100 millidegrees C. Closed loop control was provided via a sealed platinum RTD suitable for measuring temperature between −200 C and 260 C. The block is isolated from the breadboard by fiberglass washers cut from G-10 stock (PN 8667K112, McMaster-Carr Supply Company).

The Tenax™ TA resin cartridge, briefly described above, was housed in the center of the aluminum block with the cartridge heater and RTD. Tenax™ TA is a porous polymer resin composed of 2,6-diphenylene oxide. It has thermal desorption characteristics best suited for volatile organic compounds with boiling points between 80 and 200 degrees Celsius.

www.sisweb.com/index/referenc/tenaxta.htm, Scientific Instrument Services, Inc., Ringoes, N.J. shows collection and desorption concentrations (breakthrough volumes) of substances at a given temperature in Tenax™ TA. In the blue highlighted region, breakthrough volumes of greater than 10 liters per gram of resin allow for solvent collection at the noted temperatures. Conversely, in the red highlighted region, breakthrough volumes of less than 0.01 liters per gram of resin provide for solvent release. S.I.S. recommends doubling the purge gas volume to completely elute all of the analyte. Likewise, breakthrough volume should be halved when absorbing to ensure that all of the analyte remains in the resin.

The volume of gas that can purge an analyte through one gram of resin at a specific temperature is called breakthrough volume, BV:

$$BV = \frac{RT * FLOW}{AW} \qquad Equation 1$$

where BV is the breakthrough volume in liters per gram of resin, RT is the retention time in minutes, FLOW is the concentration of the carrier gas expressed in liters per ml of analyte, and AW is the absorbant weight of the resin in grams.

Readily available solvents were considered for use as test analytes based on noise-to-signature absorption ratio and absorption/desorption characteristics in Tenax™ TA resin. compares five solvents and the chemical agent simulant, dimethyl methyl phosphonate (DMMP), for use in the preconcentrator system. They have strong infrared signatures and volatility comparable to DMMP and nerve agents.

Also important to note is the ability of Tenax™ TA to thermally desorb water at temperatures just above 80 C, helping to decrease signal noise and energy transfer in downstream interrogation modules. An initial low temperature purge can be used to remove water and other interferents.

### Photoacoustic Cell

Photoacoustic (PA) detection[^{i,ii,iii}] is a highly sensitive technique that allows for much lower costs than a mercury-cadmium-telluride (MCT) detector, which generally cost between $1000 and $2000 per unit. The cost of PA detection is further reduced because it avoids the need for cryocooling the MCT detector. Cryocoolers cost between $2,000 and $25,000 depending on size, operating life and vibration levels. While thermoelectric (TE) cooling can be used with an MCT detector to avoid the cost, weight and vibrations of a cryocooler, the D* performance can suffer. An MCT detector is about 4 to 10 times more sensitive at 77K than at 230K. Cryocoolers can readily reach 77K, but until recently had been quite expensive and provided only limited lifetimes. TE coolers can only reach 230K, but are less expensive and more compact. Unfortunately, TE devices are quite inefficient. Their power requirements can at least double the handheld FT-IR instrument power budget to 30 watts total, or worse. The use of PA detection can rival the sensitivity of MCT detector with an expensive multipass gas cell. The volume of a PA cell is a better match to preconcentration than a gas cell.

The photoacoustic detector chamber can incorporate a multi-pass optical design and other features that increase the analyte signal while suppressing the undesirable background signal The volume of the cell can be on the order of 1 mL. The number of reflections and effective pathlength can be in the range of 300 passes and 3 meters respectively. The preferred photoacoustic (PA) cell can be a spherical aluminum chamber sealed on one side with an infrared window. The interior of the chamber can be coated with a gold infrared reflector bonded to the polished aluminum surface by a chromium layer. The gold coating can provide a very high infrared reflectivity in the range of 99.9% such that any radiation entering the cell can be reflected many times. The layers can be quite thin, a few tens of nanometers for the chromium and approximately 100 nanometers for the gold. The cell can have a suitable infrared transparent window for coupling the modulated beam from the interferometer to the sample gas. The window diameter should be minimized and positioned at a focus of the infrared beam, such that the reflector area is maximized in the spherical chamber. The preferred window for the cell can be zinc selenide, germanium or gallium arsenide with antireflection coatings. Several window materials are suitable, with KBr being preferred for laboratory prototypes because of its low cost and excellent IR transparency. In fielded versions, a more robust and moisture resistant material would be used. Zinc selenide is a good choice, although its high refractive index requires anti-reflection coatings to obtain a coupling efficiency equal to that of KBr. The low absorptivity of the gold coating in the PA cell can allow a large number of reflections inside of the chamber leading to a long pathlength in the gas, thereby maximizing the photoacoustic signal for a given input power. There are fundamental tradeoffs between sample chamber size, signal level, reflection losses and thermal losses to the walls. The photoacoustic signal from the wall generated by the small infrared absorption of the gold surface will be minimized by the high thermal conductivity of the aluminum substrate. This will help offset the unavoidable sensitivity reduction imposed by heat transfer from the gas to the cavity walls. The tradeoff between thermal loss, reflection loss and PA signal strength dictate an optimum size for the chamber.

It can be necessary to heat the PA cell to prevent less volatile components from condensing on the walls. From an energy perspective, the cost of heating can be negligible, especially if waste heat from the source and preconcentrator are used. However, heating is undesirable as it tends to reduce the photoacoustic signal intensity. However, sensitivity is reduced more if the analytes condense on the walls, because the high thermal conductivity can greatly reduce the signals. Thus, for each analyte of interest, there is an optimum photoacoustic cell operating temperature. The signal-to-noise ratio (SNR) of the PA signal is related to the gas temperature and is greater at lower temperatures. This can be rationalized in several ways, but one of the simplest is that the thermal noise of the gas increases with temperature.

The signal generated by infrared heating of the gas can be coupled to the microphone by a small passage drilled through the aluminum substrate. The passage must be sized to minimize loss of the reflecting surface while maximizing coupling to the microphone. Filling of the cell with effluent from the preconcentrator (described in detail above) can be controlled by valves. Further, in order to prevent damage to the microphone, it can be necessary to seal off the microphone passage during filling if the margin for pressure damage is small. The necessary isolation can be achieved by a valve system. The preferred actuation of the valve is by a gear motor or a stepper motor.

Maxon manufactures a variety of small motors, starting at a body diameter of 6 mm. The 10 mm diameter motors with gearboxes are well matched to the size and torque required in this application. For example, Maxon part number 256094 identifies a 0.75 watt motor that can be driven with 12 volts, developing 0.75 milliNewton-meters torque. As noted, the body diameter is 10 mm and the length, exclusive of the shafts, is 35 mm. Attached to a matching 256:1 gearbox (part number 110311) the torque is multiplied to 115 milliNewton-meters, more than adequate for driving the rotary valve. The gearbox adds about 5 mm, making the overall assembly about 40 mm long. Positioning can be monitored by a 256 count encoder, working from a hard stop, to provide milliradian positioning of the valve body.

### Microphones

The cost of a Bruel and Kjaer microphone (e.g., Model 4188, Copenhagen, Denmark) suitable for high sensitivity photoacoustic measurements is about US$1200, exclusive of the preamplifier. This is comparable to the cost of an MCT detector. Larson-Davis (Provo, Utah, now part of PCBPiezotronics, Depew, N.Y.) makes similar components for about US$875, but a substantially less expensive microphone can be highly desirable.

The preferred microphone can be a very inexpensive and highly sensitive MEMS device comparable to the type manufactured by Knowles Electronics (Itasca, Ill.).

Jyrki Kauppinen has recently demonstrated an optical cantilever microphone[^{xxviii,xxix}] that was claimed to increase the sensitivity of photoacoustic measurements by a factor of 100 relative to the nickel membrane microphones made by B&K and Larsen Davis. Dr. Jyrki Kauppinen's microphones are micromachined from silicon and can be produced quite economically. The micromachined portion is dramatically simpler, with complexity added in the optical sensing of the cantilever position. At the moment, the preferred microphones are the nickel-membrane type.

The conventional high performance microphone uses a very thin (40 nm) nickel membrane, which is stretched over a frame. The membrane is in close proximity to a counterelectrode. The thin layer of air trapped in the capacitor causes non-ideal effects. In some designs, a dielectric layer with embedded charge is mounted in the capacitor, producing a “prepolarized” microphone and avoiding the need for a high potential to be applied by the preamplifier. These conventional microphones are quite expensive, being in the range of $800 to $1500 each for a 12.7-mm diameter. Their performance specifications were used as a baseline for comparison of the Novusonics and the Kauppinen designs. The size of both the Larson-Davis and Brüel & Kjær microphones are not as well matched to a handheld FT-IR instrument as the micromachined devices, but they are available in commercial quantity now and work well.

### Detection Limit Model

Sound generation in the sample chamber results from rapid conversion of infrared radiation to heat by absorption and subsequent non-radiative decay of the resulting vibrationally excited molecular states. The equation of state for the gas in the sample chamber is, to a good approximation, simply PV=nRT. The energy of an ideal gas is 1.5 RT, so the pressure change can be related to the energy deposited by the infrared beam. The modulation frequencies for the bandwidth associated with the maximum absorption are determined by the scan rate of the instrument and used to compute the root-mean-square power of the acoustic signal. Scan rates between 1 and 10 per second are expected, leading to modulation frequencies in the range of 40 to 400 Hz at the low end to 400 to 4000 Hz at the high end of this range. Energy deposition in the gas in the range of 4 microjoules per modulation cycle is estimated. This gives rise to signal levels of 6.2 dB in a bandwidth of 3 Hz centered at 65 Hz for a 1 ppm concentration of a chemical agent. The estimated noise level of the baseline microphone in this same bandwidth is −24.5 dB. For some concentration levels, signal averaging over a number of modulation cycles is required to raise the SNR above unity, but it is understood that a signal at 1000 cm⁻¹ can be observed over about 64 cycles for a measurement made at 32 cm⁻¹ resolution, and 512 cycles in a measurement made at 4 cm⁻¹ resolution. For these two different resolutions, the maximum permissible throughput of the interferometer can be considerably different.

A first principles model is under development to determine the theoretical performance limits of handheld FT-IR photoacoustic instruments. The model characterizes the power transfer of the system from an IR source through the interferometer, into the sample, and to the microphone detector. The model is implemented in MATLab® (Mathworks, Natick, Mass.). The preconcentrator unit is expected to increase concentrations of airborne chemical agents by amounts in the range of 20 to 1000 fold, as described above. The source is modeled as an ideal blackbody emitter. The temperature is assumed to be 1500 Kelvin, although it likely can be possible to operate at a higher temperature with a high-efficiency source. Thus, the 1500 K figure is conservative.

The interferometer throughput is calculated using field-widening techniques, and is tied to the instrument resolution. The resolution must be tailored for the analytes and possible interferences, but generally lower resolution is favored.[^{iv,v,vi}] For example, Griffiths and Qin showed that even for compounds with spectra as similar as the three xylene isomers, the best chemometric discrimination was obtained at 32 cm⁻¹ resolution. In short, the reason is that the SNR increases very rapidly with lower resolution as this increases the maximum allowed throughput of the interferometer. Initial calculations have used the absorption profile of a chemical agent simulant as a useful starting point. The absorption coefficient was determined for the major peak in the spectrum between 1000 and 1050 cm⁻¹. A constant absorption of 12 L g⁻¹ cm⁻¹ was assumed over this entire bandwidth. The baseline microphone is the B&K model 4176 (Nærum, Denmark).

For ½″ diameter microphones of the type produced by B&K and Larson-Davis, the limiting noise performance is in the range of 15 dB over a 20 kHz bandwidth. Initial noise calculations have used only the thermal noise of the microphones since this is expected to be the dominant noise source. The source of this noise is the acoustical resistance to the flow between the microphone diaphragm and backing plate. At present a white noise spectrum is assumed, although the preamplifier noise with a 1/f character dominates at frequencies below 100 Hz. This can be refined as the model is further developed.

The thermal noise is calculated to be approximately 15 dB for the B&K and Larson-Davis microphones from the data sheets.

Kauppinen reports that their microphone achieves a sensitivity of just under one part per billion for methane, using a chopper modulated IR source and 2600 to 3400 cm⁻¹ bandpass filter. The microphone is reportedly able to measure pressure amplitudes down to 40 dB in a 100 s observation time. If this −40 dB noise amplitude is extended to a 20 kHz bandwidth, the equivalent noise pressure is found to be 23 dB, which is in the same region as current commercial microphones.

It appears that the signal (6.2 dB) generated by thermal expansion of the gas is much smaller than the nominal noise floor of the microphones (˜15 dB). This is misleading, because the 15 dB figure contains noise contributions from the entire bandwidth of 20 Hz to 20 kHz. However, it is only noise in the spectral bandwidth of the sample that affects the SNR of a particular measurement. This noise is considerably smaller and can be averaged over one or more scans. At present, the model indicates that the sensitivity of the handheld PA system can be at least in the part per billion range for a one-minute signal averaging period and that the performance of most microphones described in literature and commerce are within a few dB of each other.

The ultimate detection limits are in the range of 25 parts per trillion to about 25 parts per billion, depending on the preconcentrator efficiency and the infrared absorption spectrum of the particular analyte.

### Computer and Electronics

### Analog-to-Digital Converters

One main analog-to-digital converters (ADC) are required in the handheld spectrometer. One converter can be used to digitize the output signal from the photoacoustic detector. Another which can actually consist of two or more converters, can sample laser signals although Brault's method is preferred for data acquisition and processing. In general, the laser converters would require lower resolution and higher speed. The output of the photoacoustic detector requires more resolution, but can be operated at lower sample rates. Three main converter options are under consideration. Each of these converters offer distinct characteristics that can benefit particular needs. Characteristics that should be considered in selecting converters for the handheld spectrometer include the input signal-to-noise ratio (SNR), the input dynamic range, the output interface, the converter architecture, and the physical size. The output of the converter can be sent to the processor by a dedicated fiber optic connection. The fiber optic approach can keep digital noise from being broadcast throughout the system by the converter data lines.

The first element in the electronics after the microphone and preamplifier is the analog-to-digital converter. An excellent choice for this component is the Crystal Semiconductor 5381, (Cirrus Logic, Austin, Tex.) dual-channel 24-bit converter with a dynamic range of 1117 dB. This component is sufficient for digitizing both the infrared and laser channels at modulation frequencies up to 44 kHz. This part is roughly the size of a penny in a TSSOP24 package, with a physical area of 6.5×7.8 mm.

### Data Processing

The next stage in the electronics after the analog-to-digital converter stage is the data processing system. In most FT-IR systems, data processing is handled by a personal computer, either a notebook for portable systems, or a desktop for laboratory systems. Attractive approaches for a miniature or handheld data system are a PC-architecture that has been reduced to a single chip,[^{xxx}] or a handheld computer, such as the devices from Palm Computing (now part of 3Com, Marlborough, Mass.). The surprising aspect of the single chip implementation of the PC-architecture is that the power consumption is only 1.8 watts at 128 MHz clock speed. This chip includes a floating point coprocessor compatible with PC-based code, so is very attractive. Many of the handheld computer devices ran on Intel (Santa Clara, Calif.) StrongARM® processors. As early as 1999, these processors were operating at 750 million instructions per second, with power consumption under 0.5 watts. The StrongARM series do not have floating point coprocessors, so the comparison is not strictly equal. Either of these systems can be configured with a DSP or FPGA chip as a co-processor, if necessary for managing numerically intensive operations.

Another promising system element is a field programmable gate array (FPGA).[ ] These devices are known to use considerably less power than either a digital signal processor (DSP) or general purpose processor.[^{xxxii}] The internal architecture of FPGAs can be highly optimized for a given computational task, which provides the unusual efficiency. MAT recently has studied[^{xxxiii}] the feasibility of employing FPGA devices in Fourier transform data processing applications and found that currently available chips have sufficient capacity to process at least one channel of infrared data. Chemometrics and library searches require some additional computing cycles, but generally are not as intensive as the Fourier transformation itself. The necessary calculations can be managed readily by a desktop PC, but can be a strain for handheld computers at the present time. The ongoing advancements in computer speed/power ratio can be expected to improve at the current rate of 30% per year for some time.

### Computing Requirements

The FT-IR spectrometer core of the handheld platform eventually can be operated in several modes. These modes include step-scan, slow-scan and rapid-scan operation. One version is premised on photoacoustic detection, for which relatively slow scan speeds are preferred. The model results in the previous section indicate that the highest scan rates that can be contemplated with photoacoustic detection are about 10 per second, with a highest resolution of about 4 cm⁻¹. In practice, it is likely that 16 or even 32 cm⁻¹ operation can be preferred because of the SNR advantages. In particular, lower resolutions allow much higher interferometer throughput. Taking 10 scans per second at 4 cm⁻¹ resolution as the worst case scenario (i.e., highest data rate) would imply a laser frequency of 40 kHz. The corresponding highest IR frequency of interest would be 4 kHz. The Crystal Semiconductor (Austin, Tex.) 24-bit sigma delta analog-to-digital converters (e.g., CS5381) have output data rates of 192 kHz, which is more than adequate for 10 scans per second.

The data processing can require fringe counting of the interferometer mirror position. In the system described herein, the fringe counting electronics can consist of a few chips, taking up less than a few square centimeters of board space. The number of clock cycles required to execute these computations can be estimated accurately and used to estimate a power budget for the electronics. The major electronic components can include a dsPIC microcontroller, a field-programmable gate array and analog-to-digital converters.

### Control Board Processor Requirements

Two of the main electronics considerations are the processor unit and the analog-to-digital converters (ADC). A relatively high-resolution ADC is required to accurately digitize photoacoustic detector signals. For applications with quieter detectors such as mercury-cadmium-telluride (MCT), higher resolution ADCs can be required. A high-speed processor is required to process the digitized data to spectra and compute chemometric correlations. There are a wide variety of each of these device types available. Careful consideration is required to optimally match the characteristics of these components to the system requirements.

### Processor Solutions

Though there are a large number of possible core processors suitable for the handheld spectrometer system, two main processor architectures are under consideration at this time. Most of the data processing is the photoacoustic signal and the laser channel(s). Several of the blocks contained in the diagram are digital filters, which can require very significant processor power. Digital filters employ dedicated multiply-accumulate units to perform the required operations quickly. With the number of digital filters required, the number of multiply operations per second that a device can perform is a critical consideration.

Another critical area is processor power consumption. The estimated upper bound for the overall power budget is 20 W. This power is estimated to provide 5 W to the infra-red (IR) source, the preconcentration stage, and system electronics while the remaining 5 W are held in reserve for other requirements or for error in one of the three units. A significant portion of the electronic power can be required for analog signal conditioning throughout the system due to the fact that analog circuit performance is directly proportional to power consumption, a result of optimizing between Johnson noise and shot noise. It can be reasonably assumed that a maximum of 2 W is available to the processors, with a goal of keeping the processor power consumption under 1.5 W.

One final issue of concern for processors is the physical size. In the handheld physical layout, most of the space can be occupied by the mechanical systems required for the interferometer, source, detector, and battery units. The physical space available for electronics can be limited, and thus compact IC footprints are desirable.

Microchip dsPIC

The first processor preferred for this application is the dsPIC line from Microchip (Chandler, Ariz.). The dsPIC is designated as a digital signal controller, and was meant to be a midpoint between microcontrollers and the digital signal processor (DSP) for embedded applications. Microcontrollers are small microprocessors with limited capabilities, intended for embedded applications. As with microcontrollers, the dsPIC is available with a variety of built-in, dedicated modules, such as 16-bit timers. The main difference between the dsPIC and traditional microcontrollers is that the dsPIC has a built-in multiply-accumulate unit, a feature usually limited to DSP and other high-end processors. This feature allows the dsPIC to be useful in high-speed digital filtering applications. A picture of the specific controller under consideration, PN dsPIC30F6014.

The dsPIC30F6014 comes with several built-in features that are useful in a handheld spectrometer. This particular device uses a 16-bit arithmetic logic unit (ALU) as opposed to the usual 8-bit ALU in microcontrollers. For larger numbers (i.e., multi-byte fixed point words), the time to perform calculations is greatly reduced. This device also features several dedicated modules that can be useful. Two of the most useful are the I²C module and the data converter interface (DCI) module, since these are the two standards that can be used to communicate between modules. These protocols could be implemented in software, but dedicated modules operate independently from the core processor and therefore only require limited programming and processing for operation. This allows most of the processor to be dedicated to data flow.

The dsPIC is available in a variety of packages. The largest, the TQFP80 offers a footprint of 14.0 mm 14.0 mm. Smaller packages are available, the smallest being the QFN28 package with a footprint of 6.0 mm×6.0 mm.

The footprint is proportional to the available user input/output (I/O) and to the available resources. The amount of I/O available is not a great concern in the handheld spectrometer project since most connections to the processor can be made with the I²C interface. A greater concern can be the availability of resources, particularly the amount of on-board memory. Memory available on the dsPIC ranges from 12 Kbytes of program memory and 1024 bytes of data memory in the smallest package, to 144 Kbytes of program memory and 8192 bytes of data memory on the TQFP80. Those units with a smaller footprints also lack an I²S communications module.

The maximum clock frequency of the dsPIC is 120 MHZ, derived from a 7.5 MHz quartz crystal input and a 16× phase lock loop (PLL). Each operation requires 4 clock cycles, for a maximum of 30 million operations per second. A multiply-accumulate operation takes only one instruction cycle, but unfortunately the input and output of the multiply engine points only to specific registers. To accomplish a multiply of data in memory requires retrieving each of the operands to the designated registers, using two extra instruction cycles. In the best case, the result could remain in the accumulator for the next calculation. Thus, a minimum of 3 instruction cycles are required to execute a multiply operation, limiting the chip to a maximum of 10 million multiplies a second. This number can decrease when additional programming is required for control of the rest of the system and for managing the data in the controller. A practical estimate would indicate that 5 million multiply operations are available per second. Also, for numbers represented by more than 16-bits, at least three multiply operations are required. If two noise bits are discarded from an 18-bit ADC result, photoacoustic data might be processed successfully as 16-bit fixed point format.

The power consumption of the dsPIC is largely dependent upon the frequency at which the device operates and upon the current required by the input/output (I/O) pins on the microcontroller. However the manufacturer's data sheet specifies that it can consume 146 mA at 5 V when operating at 30 million instructions per second. This corresponds to a power consumption of about 0.75 W, which is half of the allotted power for the digital electronics.

Another option for the processor or coprocessor is the use of field-programmable gate arrays (FPGA). One possible FPGA is the Spartan 3 from Xilinx (San Jose, Calif.). Unlike a microcontroller or a DSP, which have a central ALU, an FPGA is a large number of small general-purpose logic blocks that are capable of performing several different functions. At configuration time each block is programmed to perform a specific task, much the same as setting up a large scale digital logic circuit. Since there are many small logic units, calculations are intrinsically parallel, rather than sequential as in conventional microcontroller.

### Spartan 3 FPGA

The Spartan 3 FPGA is available in varying sizes, measured by the equivalent number of logic gates, from 50 thousand gates to 5 million gates. However, the devices with larger gate counts are only available in ball-grid array (BGA) packaging. Using BGA packaging would complicate design, manufacturing, and physical constraints, and can therefore be avoided. This constraint limits the size of the FPGA used to 50 to 400 thousand gates. Preliminary estimates of the processing required for the handheld spectrometer indicate that more than 50 thousand gates can be required, and thus only the 200 (XC3S200) and 400 (XC3S400) thousand gate FPGA can be discussed here. One type of fringe counting firmware requires less than 30,000 gates, fitting comfortably in the XCS30XL.

The XC3S200 and the XC3S400 are available in three package sizes. The smallest package option, the VQ 100 package. The main difference between package options is the number of user input/output (I/O) lines available. Since the handheld spectrometer requires a relatively small number of I/O connections, there is no need to use a large package. The XC3S400 is not available on the VQ100 package. The next size package, the TQ144, can be a practical choice. The footprint of the TQ144 package is the same, regardless of the gate count, and therefore if a device with a different gate count is required, it can be swapped without system redesign.

The Spartan 3 is available with built-in multipliers. The number of multipliers available is dependent upon the gate count of the device being used. The XC3S200 is equipped with 12 dedicated multipliers, while the XC3S400 is available with 16. Although these multipliers are 18-bit units, two multipliers can be cascaded to create a single 36-bit unit. This feature can be useful if 24-bit data are obtained from an MCT detector. It is unlikely that the photoacoustic data can require this high a resolution.

The maximum clock rate of the Spartan 3 is just above 300 MHz. Since all operations can happen simultaneously in FPGA hardware, the theoretical maximum number of multiply operations is 3.912 billion multiplies per second for the XC3S200. Because of the distributed nature of the FPGA, it can be assumed that the device can operate near the theoretical performance limit. Although the distributed logic of the FPGA allows for increased speed of the processor, it also complicates power consumption estimates. Digital transistors consume power only when switching, and therefore the power consumption is highly dependent upon the clock frequency and the number of active transistors. Since the number of transistors being used is determined by the program running, actual power consumption can only be determined when the programming is complete.

A rough estimate of power consumption can be obtained using a tool at the Xilinx website (www.xilinx.com). The on-line resources offered by Xilinx include a power dissipation calculator. The estimated program resources and the clock rate are used as input. It was assumed that almost all resources were used at a frequency of 300 MHz. The one exception is that only minimal I/O was used at lower frequencies, 5 and 20 MHz. This estimation concluded that approximately 1.5 W can be required to execute this program. This estimate is approximately the goal of power dissipation for the system processor, but does represent a good upper bound for FPGA power consumption.

To provide a complete set of comparisons, another device often used to accomplish high speed digital filtering is the digital signal processor (DSP). One device of comparable capability to the XC3S400 is the TMS320DM64, which is part of the high-performance DSP line from Texas Instruments (Dallas, Tex.). Since DSP devices utilize a central ALU, module control and peripheral programming can decrease the number of multiply operations per second. The power dissipation of this device is just over 2.2 W, an increase of about 46% from the FPGA. In addition, this device is only available in a ball-grid package, which can make prototype assembly difficult.

### Power Supply

The preferred power source for the handheld spectrometer is a battery pack module. This module can be interchangeable between lithium-ion and nickel-metal hydride types. Nickel-metal hydride (NiMH) batteries, which have a fully-charged potential of approximately 1.33V, can be used for some applications. Twelve individual NiMH cells can provide a supply voltage of 16V. This single supply voltage can then be converted to a bipolar supply using a switching regulator, including a switched capacitor type. This allows for a smaller battery pack, when compared to using an additional 12 batteries to create a bipolar supply, but at the expense of additional power supply switching noise.

The most mature high-energy-density power sources for small portable instruments are lithium-ion (Li-ion) batteries. These devices provide much of the weight and power advantages of metallic-anode rechargeable (secondary) lithium batteries with greatly improved cost, safety and cycle life. The tradeoff is a slight reduction in energy density, but Li-ion cells still provide roughly double the performance of nickel-cadmium cells, and half again the performance of nickel-metal hydride cells. A variety of chemistries can be used in Li-ion cells; generally a non-metallic anode material stores lithium ions at high potential and a lithium cobalt oxide cathode reversibly absorbs the lithium ions at lower potential. The most common anode materials are carbon-based, but other materials are being actively investigated to improve performance and safety. The electrolyte is typically a propylene carbonate solution of lithium hexafluoroarsenate providing adequate performance over a wide temperature range. The nominal energy density of Li-ion batteries is 80 to 100 watt-hours per kilogram, or 36 to 45 watt-hours per pound. The nominal life of Li-ion batteries is 500 cycles, with very low tolerance for overcharge. For an instrument used on a daily basis for eight hours, five days per week, this cycle life can correspond to replacement of both battery packs approximately every year. Elaborate overcharge protection is required because overcharging can result in metallic lithium being plated out on the anode, with the potential for explosion and fire. Even charging too fast can cause explosion and fire. The prevalence of large Li-ion cells in laptop computers, which are allowed on passenger aircraft, however, attests to their safety in practical everyday use.

Nickel-metal hydride batteries are less expensive than Li-ion types and offer roughly ⅔ of the performance. They are widely available from commercial sources and have become the dominant rechargeable battery in the consumer markets during the past 5 years. The cost of a handheld or miniature spectrometer system can be reduced by using NiMH cells, at the expense of a modest increase in overall weight or corresponding reduction in discharge time. Four of these cells can provide about 10 watt-hours of useful output. A battery pack of 12 AA cells could operate the proposed handheld FT-IR/PAS instrument for about two hours. The life of NiMH batteries is usually quoted as being between 500 and 3000 cycles. For law enforcement, where the handheld FT-IR spectrometer can be used in drug interdiction, the reduced power density is less of a problem. The typical law enforcement use can be intermittent and vehicle or line power usually can be available for recharging between uses.

The power budget for a handheld FT-IR instrument is in the range of 15 to 20 watts. The power required for the preconcentrator, the infrared source and the system electronics are estimated at 5 watts each, for a total of 15 watts; the extra 5 watts is held in reserve as a margin for error. In comparison, many laptop computers require 60 watts, and can be powered for an hour from a lithium-ion battery weighing about one pound. Thus, a battery pack weighing about one pound can be able to run the handheld FT-IR/photoacoustic system in continuous operation for about three to four hours between recharges. If the battery module interface is provided with the ability for quick interchange, a pair of batteries could be used to run the instrument continuously. One battery pack can be recharged (e.g., from a vehicle power system), while the other pack is being used to power the handheld instrument. Every three or four hours, the battery packs can be exchanged.

The highest energy density of practical primary (non-rechargeable) lithium cells is about 280 watt-hours per pound, while the highest energy density of secondary (rechargeable) lithium-ion cells is about 60 to 100 watt-hours per pound. Thus, the potential operating time of the same battery weight could be extended to 16 hours for critical missions, if more expensive (and expendable) lithium-thionyl chloride batteries are used. For a handheld instrument, the total weight budget is about 2 pounds. It can be preferable to have a much lower instrument weight, such as one pound, but a fuel cell or a microgenerator power source is required to achieve these small weights.

### Protection

To buffer the instrument from environmental temperature changes and the impacts inherent to field use, the outer housing can be lined with shock-absorbing foam. In production, such a buffer can be molded. For prototyping purposes silicone foam (PN 85925K403, McMaster-Carr Supply Company, Santa Fe Springs, Calif.) is suitable. Aluminum construction can provide for relatively isothermal conditions inside the instrument, because of the high thermal conductivity of aluminum. The large heat capacity of aluminum can buffer the rate of change of temperature, while the high thermal conductivity tends to insure that the components are isothermal. An alternative material for instrument construction, particularly mass production, is stable, low-coefficent glass-filled polymers like Torlon®. These materials can be injection molded, but do not have the favorable thermal properties of aluminum. Irrespective of the construction material, provision is made for dissipating 15 watts of waste heat from the source, batteries, preconcentrator and computer board.

The heat can be dumped by the use of a very small computer fan, such as the PN GB0504AFB2-8, from Sunon, Inc. (Brea, Calif.) blowing through a portion of the aluminum frame/housing to cool the entire instrument. The Sunon fan is rated at 0.2 watts and moves 1.5 cubic feet per minute of air (40 liters per minute). The 40 mm×40 mm by 7 mm footprint is well-matched to a handheld instrument. By adjusting the speed (voltage) of the blower, the rate of heat dissipation can be accurately controlled to maintain a nearly constant internal instrument temperature in environments from −50 C to +50 C. The heat capacity of air is about 1 J/gram-C, and the density is about 1.2 grams per liter. Thus, 40 liters of air per minute with a temperature rise of 20 C is sufficient to dissipate 800 Joules per minute, or about 14 watts. A variety of larger and smaller fans are also available.

Aluminum is an attractive material for fabrication. It is relatively inexpensive, stiff and has a high thermal conductivity, which tends to minimize distortions caused by thermal gradients. It readily can be cast and machined. Aluminum is susceptible to mechanical damage—bending—if dropped, providing another reason to cover the instrument with a layer of foam insulation. The insulation also can minimize the rate of temperature change caused by the environment. Aluminum can be die cast or investment cast inexpensively. However, cast aluminum cannot be diamond turned because of the oxide inclusions. Diamond turning is attractive because optical surfaces can be formed directly on the construction material. Preferably, the aluminum surfaces are then protected by coating with magnesium fluoride. Extrusions are a very efficient method for producing shapes that can be useful for the modules.

Aluminum forgings and extrusions can be diamond turned to directly produce optical surfaces. Thus, if casting is used for fabrication, the preferred method of forming inexpensive, high quality optical surfaces is replication or epoxy bonding.

The interconnects between components can use Augat or Pylori pins (both companies are subsidiaries of Tyco Electronics Corporation, Harrisburg, Pa.). These pins have intrinsic spring loading and can be submerged in the faces of the modules where they meet. However, the detector module can require either a high quality analog connection to the electronics module, or a high-speed serial connection. Bruker have filed patent applications[^{xxxiv}] on mounting an ADC in a detector module, so the ADC may be mounted in the adjacent module.

### Display/User Interface

A handheld or miniature FT-IR spectrometer can require several types of user interfaces. For certain applications, such as scientific field work, where the user understands many aspects of spectrometry, a high level of access to internal operation can be required. For unskilled users, the instrument can provide a very simple user interface with a minimum number of indicators. An example might be a button to actuate the sampling cycle, and two or three lights to indicate the measuring status. Red, yellow and green LEDs can indicate dangerous levels of organic vapors, questionable levels and safe levels, respectively. No graphical display may be required for unskilled users, although remote support can still be provided.

### Computer/Electronics/Software/Display

A computer is required to control the instrument, manage data collection, transform interferograms to spectra and compute chemometric correlations. The most computationally demanding tasks are data collection and processing. A display is required to convey information to the user. For most users, the display can simply indicate alarms, battery power and concentrations of chemicals detected. For more advanced users, particularly for application trials and troubleshooting, a fully functional FT-IR spectrometer software suite can be required.

A variety of compact computers are suitable for these purposes. For example, the Palm Pilot series (Palm, Inc., Sunnyvale, Calif.) and similar palmtop computers have a very useful display size. Their computational power is much less than a desktop, but still better than the DSPic microcontrollers, principally because they have floating point processors. The computational burden of the FT-IR spectrometer is insignificant compared to the processing power of a desktop personal computer. However, the power budget for the electronics is a very modest 5 watts, much less than the typical 100 watts for a desktop CPU.

For an embedded processor, such as the dsPIC® (Microchip, Inc., Chandler, Ariz.) family, software to allow control of the instrument is sufficient, with the bulk of data processing for development testing taking place on PCs networked to the embedded processor.

A variety of small displays are available for the front panel of a handheld spectrometer. Such an instrument is likely to be too small for a functional keyboard. The preferred computer is off-the-shelf hardware, such as the Palm Pilot, or an equivalent palmtop computer. The typical user input mechanism is graffiti, for which any pen or stick can be used as a stylus. The processors in these handheld computers have reached 150 million floating point operations per second, and have lighted color displays. Further, because they are mass produced, these computer are very inexpensive. The Palm Zire 31, which provides a 160×160 pixel monochrome display and the Palm E2 are the most preferred handheld computers.

The principles, embodiments and modes of operation of the present inventions have been set forth in the foregoing provisional specification. The embodiments disclosed herein should be interpreted as illustrating the present invention and not as restricting it. The foregoing disclosure is not intended to limit the range available to a person of ordinary skill in the art in any way, but rather to expand the range in ways not previously considered. Numerous variations and changes can be made to the foregoing illustrative embodiments without departing from the scope and spirit of the present inventions. In particular, these facets of the invention or inventions may be combined in new and useful ways.

Some of the aspects of these inventions have been developed at Government expense. As such, the Government may have certain rights in these inventions.

### BRIEF DESCRIPTION OF THE DRAWINGS

FIG. 1 shows a block diagram of an interferometric spectrometer with photoacoustic detection.

FIG. 2 shows a diagram of a high-efficiency infrared source.

FIG. 3 shows a schematic of a field-widened interferometer.

FIG. 4 shows a diagram of a compensator mounting plate.

FIG. 5 shows a diagram of a resin preconcentrating system for vapors.

FIG. 6 shows a flow diagram of the spectrometer system.

FIG. 7 shows a passive remote spectrometer geometry.

### DETAILED DESCRIPTION

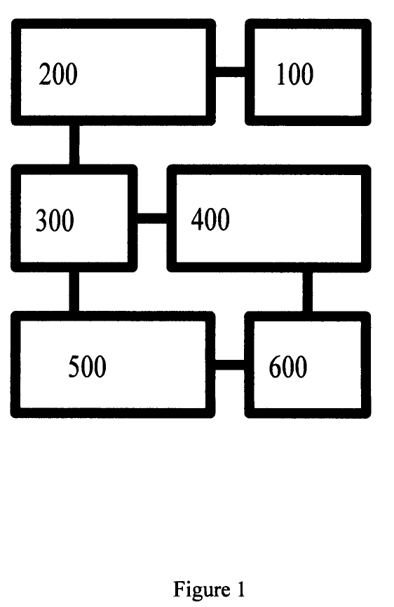

FIG. 1 shows a block diagram of a spectrometer system. The components are a source 100 of radiant energy, an interferometer 200 for modulating the radiant energy, a photoacoustic detector 300, resin preconcentrator 400, computer 500 and battery 600. Together these elements comprise a spectrometer system suitable for detection of chemical substances, most usually in vapor form. Pertinent details of the system elements are described below relative to the other figures.

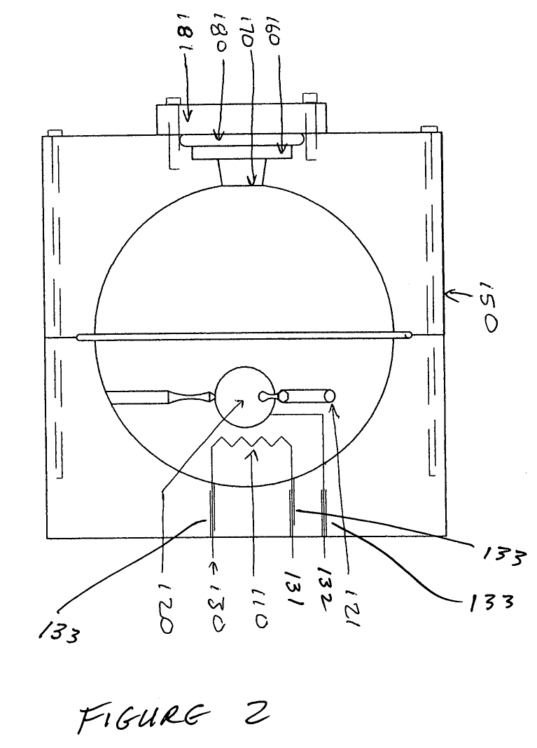

FIG. 2 shows a diagram of a high-efficiency infrared source. The source element 120 is enclosed in a vacuum-tight enclosure 150 that can be highly evacuated to remove gases. The source element is supported by highly insulating material 121, which may be zirconium oxide or halfnium oxide. Preferably, the source element is heated by electron impact. A filament 110 is heated by the flow of current from an external power supply. A potential is applied to the filament 110 and the housing 150 that is negative relative to the potential applied to the source element 120 via wire 132. The filament power leads 130, 131 and the wire 132 to the source element are sealed with glass-to-metal bonds 133. A suitable potential and current for the source are 300 volts at 10 milliamperes.

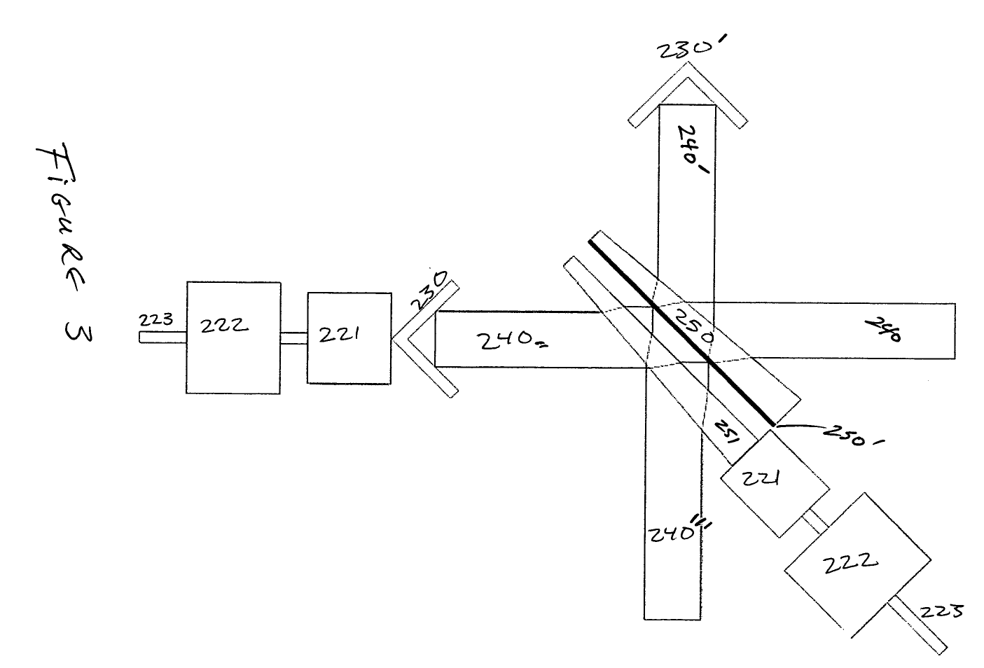

FIG. 3 shows a diagram of a field widened interferometer. The general geometry of the interferometer has been described by Doyle in the literature. Hollow cube corner retroreflectors 230 and 230′ are used return beams back through prisms 250 and 251. The source beam 240 impinges on the beamsplitter element 250, where it is divided by the coating 250′ into two beams 240′ and 240″. One of the two beams passes through the compensator element 251, which also is wedged by about 15 degrees. The two beams propagate to the terminal mirrors 230 and 230′ respectively, where they are returned to the beamsplitter after reflection. The compensator 251 is mounted on a translation stage 221 which may be a ball slide suitable for precision motion. The motion is driven by a motor 222 which may be a brushless DC motor. The preferred drive for the brushless motor 222 is linear to avoid electromagnetic interference. One of the cube corner mirrors 230 is mounted on a motion stage 221 for translation by a motor 222 such that the interferometer field of view can be adjusted during scanning. Doyle nor any other author has taught the advantages of field-widening this interferometer geometry by coupled scanning of the two elements 230 and 251.

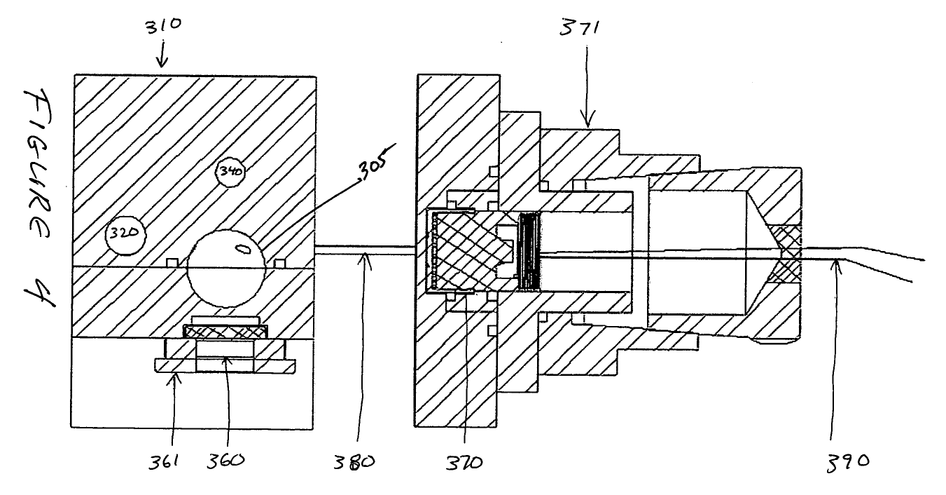

FIG. 4 shows a cross-section of a photoacoustic detector suitable for measuring spectra of gas phase species. The elements of the cell are a body 310, a window 360, a microphone 370, and a reflective cavity 305. A beam of radiant energy modulated by the interferometer is passed through the window 360. The radiant energy then enters the cavity 305 where some of it is absorbed by the sample. The sample may be heated by the radiant energy such that its pressure increases, causing a signal to propagate through the transfer tube 380 to the microphone element 370. The microphone element is sealed by a clamp mechanism 371. The signal from the microphone is amplified and passed to a computer.

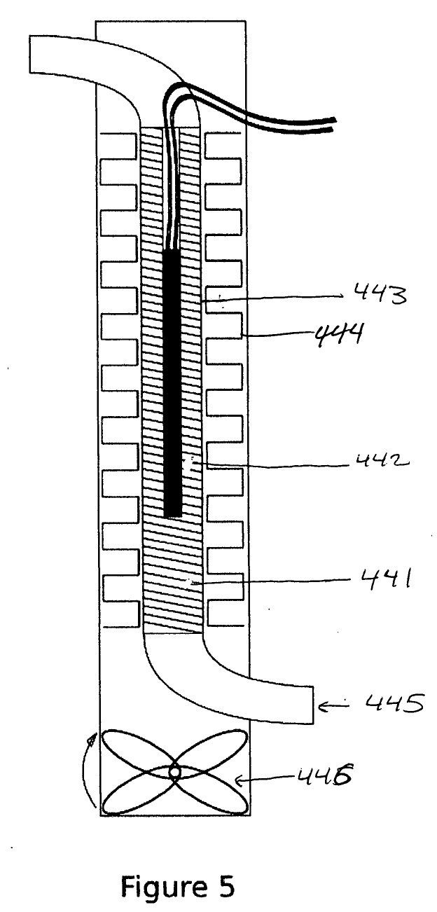

FIG. 5 shows a resin-based preconcentration system. The resin 441 may be Tenax, activated carbon, or a variety of other materials that are recommended in the scientific literature. The resin is encapsulated in a tube 443, with an embedded heater element 442. The resin is held in a porous metal foam also indicated by 441 such that it is thermally coupled to the tube 443. The outside of the tube 443 is further coupled to a row of heat sinks 444. This arrangement has the effect of thermally coupling the resin to a flow of air that may be induced by a fan 446 that blows over the heat sinks 444. Thus, the tube 443 and resin 441 can be very rapidly cooled, as well as rapidly heated by passing a current through the heater element 442.

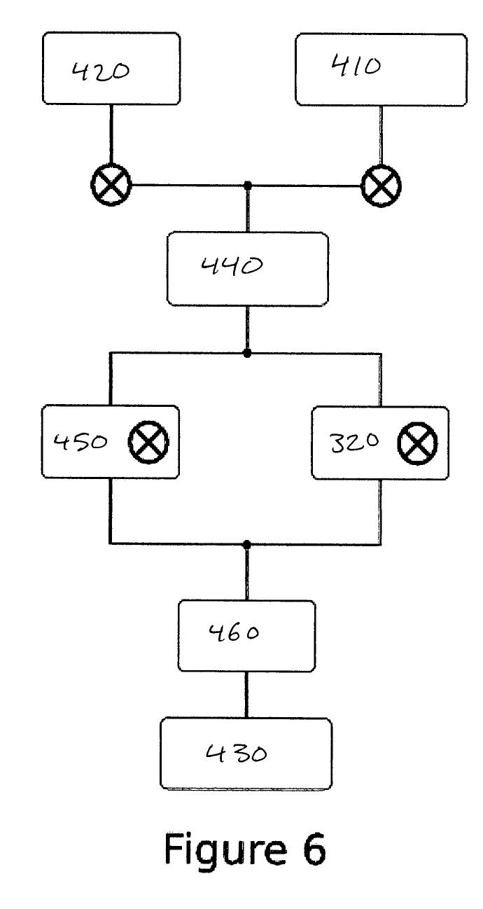

FIG. 6 shows a flow diagram for the sampling system, including the PA cell and resin preconcentrator. A pump 460 drives the flow of sample 410 and purge gas 420 through the system. In general, ambient air or other sample gas 410 is drawn over the preconcentration resin 450 for a period of time. Valves indicated by x control the flow of analyte through the system, which is understood to be under the control of a computer (600 of FIG. 1). After a suitable time period, which depends on temperature and analyte concentration, the flow of sample 410 is through the resin 440 is stopped by the program. The preconcentration resin is heated by the passage of current through the resin cartridge 440 to a predetermined temperature.

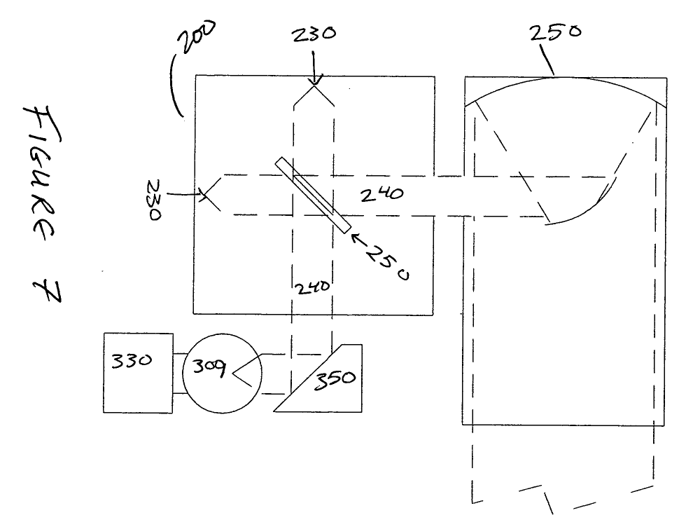

FIG. 7 shows a diagram of another embodiment of a miniature field-widened interferometric spectrometer. A telescope 250 is coupled to an interferometer 200 such that the radiation from a source is modulated. The resulting modulated beam is passed to a cryogenic detector 309, which may be cooled with a cryogenic refrigerator 330. Such a geometry may be very useful in unmanned aerial vehicles for detecting clandestine manufacture of chemical substances. The advantage of the field-widened spectrometer is the compact size.

What is claimed is:

1. A spectrometer, comprising:
a source of a beam of radiant energy;
an interferometer for modulating the beam of radiant energy;
a scanning drive for the interferometer;
a resin preconcentrator system;
a chamber for interacting the modulated radiant energy with a sample;
a pressure detecting sensor;
a control, data acquisition and processing electronic system;

2. A spectrometer, comprising:
a source of a beam of radiant energy;
an interferometer for modulating the beam of radiant energy;
said interferometer being field widened;
said interferometer having a an aperture of less than 2 inches;
a detector;
a control, data acquisition and processing electronic system;
a system weight less than 4 pounds;
an system volume less than 2 liters;
